(19) United States
(12) Patent Application Publication
(10) Pub. No.: US 2010/0224612 A1
(43) Pub. Date: Sep. 9, 2010

(54) SHEET HEATING ELEMENT

(75) Inventors: Naohito Asami, Nara (JP); Yoshimitsu Fujiwara, Nara (JP); Kazumi Nagayama, Nara (JP); Norio Abe, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/159,458

(22) PCT Filed: Dec. 26, 2006
(86) PCT No.: PCT/JP2006/325954

§ 371 Date: Jun. 27, 2008

(30) Foreign Application Priority Data
Dec. 27, 2005 (JP) 2005-374452
Dec. 11, 2006 (JP) 2006-332996

(51) Int. Cl. H05B 3/28

(52) U.S. Cl. 219/217; 219/544; 219/548

(57) ABSTRACT

An object of the invention is to provide a highly durable sheet-heating element that has flexibility for making a seat more comfortable, that alleviates load stress for a heater wire while being seated, and that prevents the heater wire from being disconnected.

Since a sheet-heating element related to the invention has a configuration in which a base member (11) of a sheet-heating element (10) is made of a flexible non-woven, it is possible to obtain flexibility for making the seat more comfortable. Also, since a surface of the base member (11) is subjected to a calender process so as to harden the surface, it is possible to stably obtain a hardness of for preventing a heater wire (12) from being disconnected when the load stress occurs while being seated. Accordingly, it is possible to make the seat more comfortable and to obtain high durability for preventing the heater wire (12) from being disconnected when the load stress occurs while being seated.

### TECHNICAL FIELD

The present invention relates to a sheet-heating element used for a seat, and more particularly, to a sheet-heating element mounted to a seat of a vehicle.

### BACKGROUND ART

In the past, as a heating technique used for a seat of a vehicle, heating was generally carried out, by mounting a sheet-heating element to the seat.

In addition, in such a sheet-heating element mounted to the seat, a flexibility of a base member is needed in order to make the seat more comfortable. Also, a hardness of the base member is needed. This is because load stress directly occurs in the heater configured by a heater wire while being seated, and thus the hardness of the base member is needed in order to prevent the heater wire from being disconnected. For this reason, there is disclosed a base member configured by raising a nap on a surface opposite to a hold surface of the heater wire (for instance, see Patent Document 1).

FIG. 6 illustrates a known sheet-heating element disclosed in the above-described Patent Document. As shown in FIG. 6, a sheet-heating element 1 includes a base member 2 of which one surface is napped, a heater wire 4 which is sewed to a surface opposite to a nap surface 3 of the base member 2 to be thereby held thereto, and a sewing threads 5 which holds the heater wire 4 by a sewing operation.

In addition, there is disclosed a base member configured by entangling fibers of a non-woven fabric with a ground fabric so as to allow the ground fabric to be integrally formed with the non-woven fabric (for instance, see Patent Document 2).

FIG. 7 illustrates a known sheet-heating element disclosed in the above-described Patent Document. As shown in FIG. 7, a sheet-heating element 6 has a configuration in which a base member 9 is configured as an incorporated member by entangling fibers of a non-woven fabric 8 with a ground fabric 7.

Patent Document 1: JP-A-H03-145089

Patent Document 2: JP-A-H05-021140

### DISCLOSURE OF THE INVENTION

### Problem that the Invention is to Solve

However, in the known configuration, since the base member 2 becomes flexible by use of the nap, when a thickness of the base member 2 is not uniform or a depth of the nap is not uniform, a height of the nap is not stable, and thus a desired hardness is not stably obtained. As a result, a problem arises in that it is not possible to simultaneously obtain both the flexibility of the base member 2 for making the seat more comfortable and the hardness of the base member 2 for preventing the heater wire 4 from being disconnected when the load stress occurs while being seated.

In addition, in another known configuration, since the base member 9 is configured as an incorporated member by entangling the fibers of the non-woven fabric 8 with the ground fabric 7, when the load stress is repeated while being seated, the fibers of the non-woven fabric 8 entangled with the ground fabric 7 become gradually loose. Accordingly, the hardness of the base member 9 becomes weak and consequently the fibers of the non-woven fabric 8 entangled with the ground fabric 7 forming the base member 9 are loosened, so that interlayer separation occurs between the ground fabric 7 and the non-woven fabric 8. As a result, a problem arises in that it is not possible to maintain the hardness of the base member 9 for preventing the heater wire 4 from being disconnected.

The present invention solves the above-described problems, and an object of the invention is to provide a highly durable sheet-heating element that has flexibility for making a seat more comfortable, that alleviates load stress for a heater wire while being seated, and that prevents the heater wire from being disconnected.

### Means for Solving the Problem

In order to solve the above-described problems, there is provided a sheet-heating element related to the invention in which a surface of a base member is configured to be hardened by performing a calender process to a surface of a non-woven fabric.

Accordingly, since the base member of the sheet-heating element is made of a flexible non-woven fabric, it is possible to obtain flexibility for making the seat more comfortable. Also, since the surface of the base member is configured to be hardened, by the calender process, it is possible to stably obtain the hardness for preventing the heat wire from being disconnected when the load stress occurs while being seated. Accordingly, it is possible to provide a highly durable sheet-heating element capable of making the seat more comfortable and preventing the heater wire from being disconnected when the load stress occurs while being seated.

### Advantage of the Invention

According to the sheet-heating element related to the invention, it is possible to more stably obtain the flexibility for making the seat more comfortable and the hardness for preventing the heater wire from being disconnected when the load stress occurs while being seated. Accordingly, it is possible to provide the highly durable sheet-heating element capable of making the seat more comfortable and preventing the heater wire from being disconnected when the load stress occurs while being seated.

### BRIEF DESCRIPTION OF THE DRAWINGS

FIG. 1 is a perspective diagram illustrating a sheet-heating element related to a first embodiment of the invention.

FIG. 2 is an enlarged sectional diagram illustrating the sheet-heating element related to the first embodiment of the invention.

FIG. 3 is a perspective diagram illustrating the sheet-heating element related to a second embodiment of the invention.

FIG. 4 is an enlarged sectional diagram illustrating the sheet-heating element related to the second embodiment of the invention.

FIG. 5 is an enlarged sectional diagram illustrating the sheet-heating element related to a third embodiment of the invention.

FIG. 6 is an enlarged side diagram illustrating the sheet-heating element related to a known example.

FIG. 7 is an enlarged sectional diagram illustrating the sheet-heating element related to another known example.

### Description of Reference Numerals and Signs

10: SHEET-HEATING ELEMENT

11: BASE MEMBER

11a: WEAK CALENDER SURFACE

11b: STRONG CALENDER SURFACE

12: HEATER WIRE

### BEST MODE FOR CARRYING OUT THE INVENTION

A first aspect of the invention provides a sheet-heating element including a base member and a heater wire disposed on the base member, wherein a surface of the base member is configured to be hardened by performing a calender process to a surface of a non-woven fabric. With such a configuration, it is possible to stably obtain flexibility for making a seat more comfortable and hardness for preventing a heater wire from being disconnected when load stress occurs while being seated. Accordingly, it is possible to provide the highly durable sheet-heating element capable of making the seat more comfortable and preventing the heater wire from being disconnected when the load stress occurs while being seated.

In a second aspect of the invention, the heater wire that is stronger than a surface hardness of the base member, is disposed on a surface of the base member of which a surface hardness is strong. With such a configuration, it is possible to make the seat more comfortable without deteriorating the flexibility of the surface having a weak surface hardness of the base member.

In a third aspect of the invention, only one surface of the base member is configured to be hardened by performing the calender process, thus because the only one surface is hardened, it is possible to further improve the flexibility of the surface not being hardened and thus to further improve the flexibility for making the seat more comfortable.

In a fourth aspect of the invention, the base member is made of a non-woven fabric obtained by mixing fibers having different melting points with each other. With such a configuration, it is possible to harden a surface of the base member by melting only the fiber having a low melting point. Accordingly, it is possible to more stabilize a surface hardness of the non-woven fabric. Therefore, it is possible to more stably obtain the flexibility for making the seat more comfortable and the hardness for preventing the heater wire from being disconnected when the load stress occurs while being seated.

Hereinafter, exemplary embodiments of the invention will be described with reference to the accompanying drawings. In addition, the invention is not limited to the exemplary embodiments.

### First Embodiment

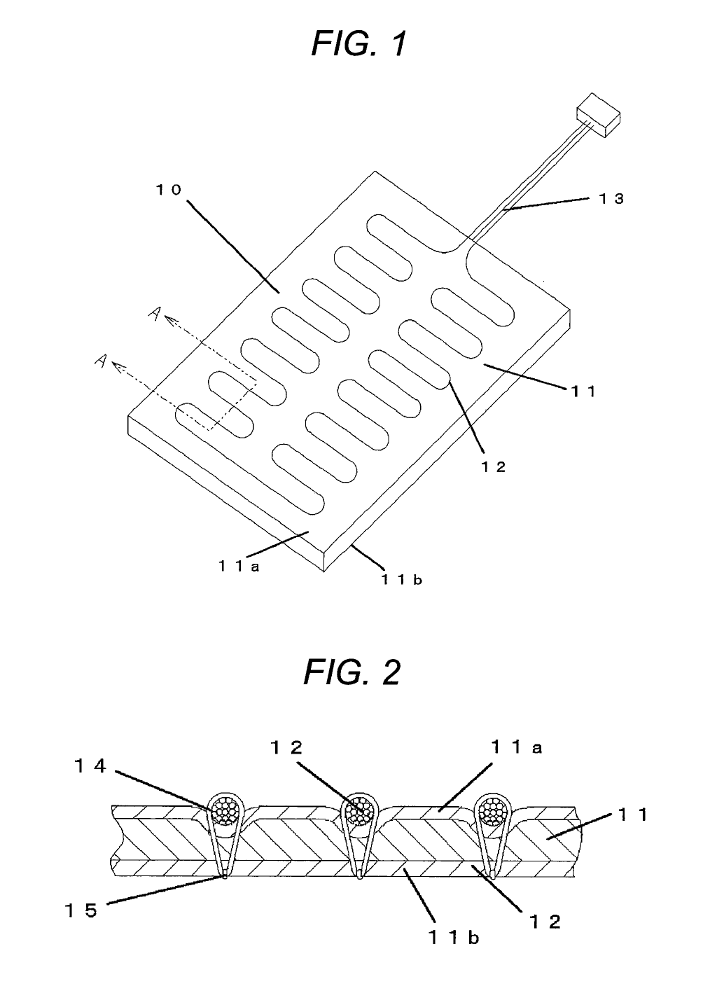

FIG. 1 is a perspective diagram illustrating a sheet-heating element related to a first embodiment of the invention. FIG. 2 is an enlarged sectional diagram taken along the line A-A shown in FIG. 1.

In FIG. 1, a sheet-heating element 10 includes a base member 11 which is obtained by hardening a surface of a needle-punched non-woven fabric made from chemical fibers such as polyester fibers or polypropylene fibers or natural fibers such as cottons by performing a calender process, a heater wire 12 which is obtained by twisting a plurality of wires having an insulation layer made from polyurethane with a surface of a copper and silver alloy wire using strengthening effect of metallic fibers disposed on the base member 11, and an electrical supply wire 13 that supplies electrical power to the heater wire 12.

Here, the calender process will be described. The calender process indicates a process technique that manufactures a sheet having an identical thickness by using a machine having a plurality of heavy rolls coming into rolling contact with each other by mechanic pressure or hydraulic pressure and which is mainly used for finishing textiles. Exemplary types includes a type in which an inner portion of the roll can be heated or not, a type in which all rolls rotate at the same surface speed, and a type in which a polished thermo roll rotates faster than the other roll. Typical examples include a simple roll calender, an emboss calender having a thermo roll with unevenness, a Schreiner calender having numerous parallel thin lines are incused, a soft polishing felt calender, a friction calender, and the like.

Next, copper and silver alloy using strengthening effect of the metallic fibers will be described. The copper and silver alloy using strengthening effect of the metallic fibers has a complex structure in which copper solid solution and copper and silver eutectic crystal are respectively formed into a fiber shape by stretching textures while extracting casting alloy by alternatively performing a heat-treatment and cold-working to casting alloy composed of eutectic crystal and primary crystal copper solid solution obtained by melting and quenching copper mixed with silver, thereby improving stretching strength or bending strength several tens times larger than that of the known product. Since the stretching strength or the bending strength of the copper and silver alloy is high, such copper and silver alloy can be sewed to the base member by a sewing machine, and thus it is possible to easily manufacture the sheet-heating element.

As shown in FIG. 2, the base member 11 is a non-woven fabric of which front and rear surfaces respectively have different calender strength, and the surfaces of the base member 11 are respectively formed by a weak calender surface 11a having a weak surface hardness and a strong calender surface 11b having a strong surface hardness.

In addition, the heater wire 12 is disposed on the weak calender surface 11a of the base member 11 and is sewed to the base member 11 by an upper thread 14 and a lower thread 15 to be thereby fixed thereto.

Hereinafter, an operation of the sheet-heating element with the above-described configuration will be described.

First, since the base member 11 of the sheet-heating element 10 is made of a flexible non-woven fabric, it is possible to obtain flexibility for making the seat more comfortable. Also, since the surface of the base member 11 is configured to be hardened by the calender process, it is possible to stably obtain a hardness for preventing the heat wire 12 from being disconnected when load stress occurs while being seated. Accordingly, it is possible to provide the highly durable sheet-heating element 10 capable of making the seat more comfortable and preventing the heater wire 12 from being disconnected when the load stress occurs while being seated.

In addition, since the base member 11 is made of a non-woven fabric obtained by mixing fibers having different melting points, it is possible to harden a surface of the base member 11 by melting only the fiber having a low melting point. Accordingly, it is possible to more stabilize a hardness of a surface of the base member 11. Therefore, it is possible to more stably obtain the flexibility for making the seat more comfortable and the hardness for preventing the heater wire 12 from being disconnected when the load stress occurs while being seated.

### Second Embodiment

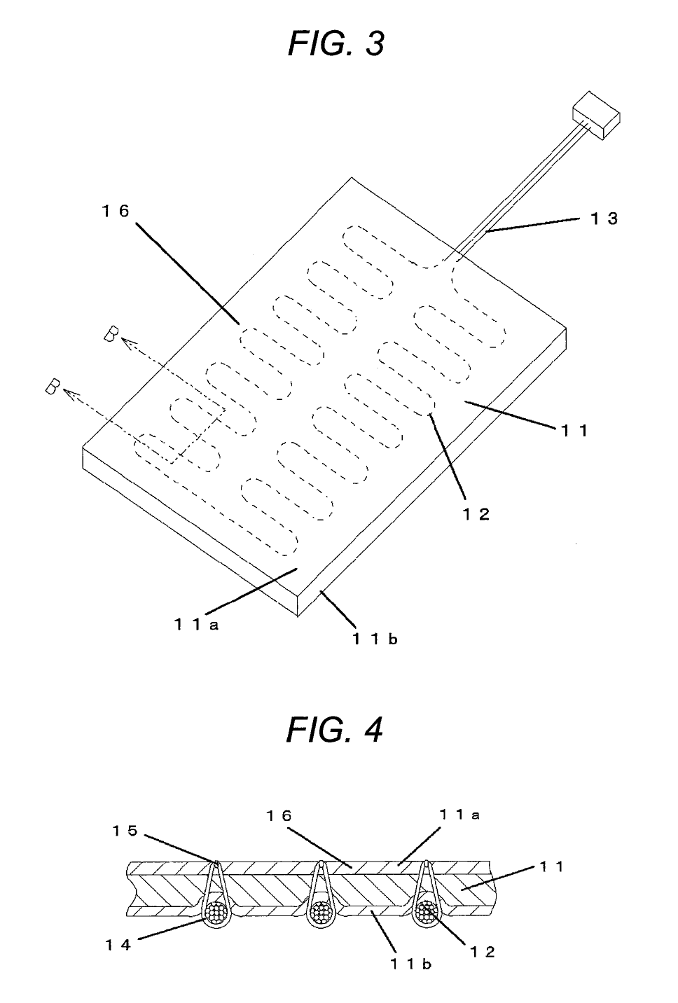

FIG. 3 is a perspective diagram illustrating the sheet-heating element related to a second embodiment of the invention. FIG. 4 is an enlarged sectional diagram taken along the line A-A shown in FIG. 3. The same reference numerals are given to the same parts as those of the first embodiment, and different parts from those of the first embodiment will be described.

In FIGS. 3 and 4, the base member 11 of a sheet-heating element 16 is a non-woven fabric of which front and rear surfaces respectively have different calender strength, and the surfaces of the base member 11 are respectively formed by the weak calender surface 11a having a weak surface hardness and the strong calender surface 11b having a strong surface hardness. In addition, the heater wire 12 is disposed on the strong calender surface 11b of the base member 11 and is sewed to the base member 11 by the upper thread 14 and the lower thread 15 to be thereby fixed thereto.

Hereinafter, an operation of the sheet-heating element with the above-described configuration will be described.

Since the heater wire 12 having a surface hardness stronger than that of the base member 11 is disposed on the strong calender surface 11b having a strong surface hardness of the base member 11, it is possible to make the seat more comfortable without deteriorating the flexibility of the weak calender surface 11b having a weak surface hardness of the base member 11.

In addition, since the base member 11 is made of a non-woven fabric obtained by mixing fibers having different melting points, it is possible to harden a surface of the base member 11 by melting only the fiber having a low melting point. Accordingly, it is possible to more stabilize hardness of a surface of the base member 11. Therefore, it is possible to more stably obtain the flexibility for making the seat more comfortable and the hardness for preventing the heater wire 12 from being disconnected when the load stress occurs while being seated.

### Third Embodiment

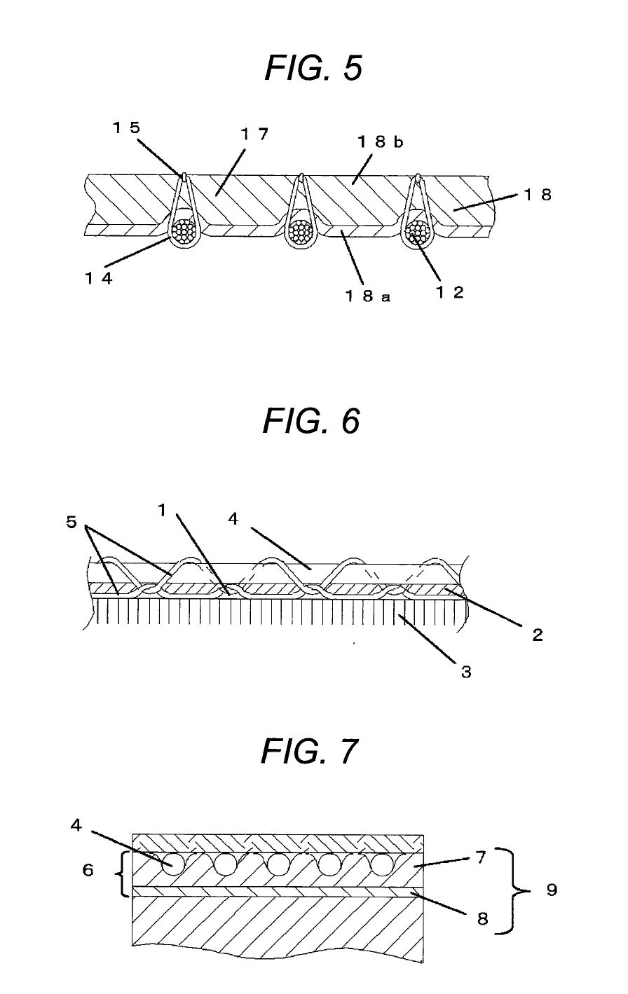

FIG. 5 is an enlarged sectional diagram illustrating the sheet-heating element related to a third embodiment of the invention. The same reference numerals are given to the same parts as those of the first embodiment, and different parts from those of the first embodiment will be described.

In FIG. 5, a sheet-heating element 17 includes a base member 18 made of a non-woven fabric of which one surface is subjected to the calender process and in which different fibers having different melting points are mixed with each other. The front and rear surfaces of the base member 18 are respectively formed by a calender process surface 18a and a calender non-process surface 18b. In addition, the heater wire 12 is disposed on the calender process surface 18a of the base member 18, the calender surface having been subjected to the calender process, and is sewed to the base member 18 by the upper thread 14 and the lower thread 15 to be thereby fixed thereto.

Hereinafter, an operation of the sheet-heating element with the above-described configuration will be described.

Since the one surface of the base member 18 is hardened by performing the calender process to only the one surface, it is possible to further improve the flexibility of the calender non-process surface 18b not being hardened and thus to further improve the flexibility for making the seat more comfortable.

In addition, since the heater wire 12 is disposed on the calender process surface 18a, the heater wire 12 having a surface hardness stronger than that of the base member 18 is disposed on the calender process surface 18a having a strong surface hardness of the base member 18. Accordingly, it is possible to make the seat more comfortable without deteriorating the flexibility of the calender non-process surface 18b having a weak surface hardness of the base member 18.

In addition, since the base member 18 is made of a non-woven fabric obtained by mixing fibers having different melting points with each other, it is possible to harden a surface of the base member 11 by melting only the fiber having a low melting point. Accordingly, it is possible to more stabilize a surface hardness of the base member 18. Therefore, it is possible to more stably obtain the flexibility for making the seat more comfortable and the hardness for preventing the heater wire 12 from being disconnected when the load stress occurs while being seated.

While the invention has been described with reference to the specific embodiment, it should be understood, of course, that various modifications or corrections may be readily made by those skilled in the art without departing from the spirit and the scope of the invention.

This application claims the benefit of Japanese Patent application No. 2005-374452 filed on Dec. 27, 2005 and Japanese Patent application No. 2006-332996 filed on Dec. 11, 2006, the entire contents of which are incorporated herein by reference.

### INDUSTRIAL APPLICABILITY

As described above, according to the sheet-heating element related to the invention, it is possible to provide the highly durable sheet-heating element capable of making the seat comfortable and preventing the heater wire from being disconnected when the load stress occurs while being seated, and thus to suitably apply the sheet-heating element to seats of an electric train and an airplane or a heat massage chair.

1. A sheet-heating element comprising:
a base member; and
a heater wire disposed on the base member;
wherein a surface of the base member is configured to be hardened by performing a calender process to a surface of a non-woven fabric.

2. The sheet-heating element according to claim 1, wherein the heater wire is disposed on a surface of the base member of which a surface hardness is strong.

3. The sheet-heating element according to claim 1 or 2, wherein only one surface of the base member is configured to be hardened by performing the calender process.

4. The sheet-heating element according to claim 1 or 2, wherein the base member is made of a non-woven fabric obtained by mixing fibers having different melting points with each other.
